(19) United States
(12) Patent Application Publication
(10) Pub. No.: US 2015/0134639 A1
(43) Pub. Date: May 14, 2015

(54) Inline Commenting on Social Threads

(71) Applicant: Microsoft Corporation, Redmond, WA (US)

(72) Inventors: Andrew Salituri, Seattle, WA (US); Nektarios Ioannides, Bellevue, WA (US); Charles W. Clines, Bellevue, WA (US)

(73) Assignee: Microsoft Corporation, Redmond, WA (US)

(21) Appl. No.: 14/078,955

(22) Filed: Nov. 13, 2013

(51) Int. Cl. G06F 17/30

(52) U.S. Cl. CPC G06F 17/30528
USPC 707/722

(57) ABSTRACT

Systems, methods and computer-readable are presented for enabling a computer user to add content to a social content item of a social content thread hosted by a third party social networking site. In response to a search query, a search engine generates a search results page that includes at least one social content item that relates to the search query from a third-party social networking site. The search results page includes a user-actionable control by which the requesting computer user can add content to the content thread of the social content item from within the search results page. By interacting with the user-actionable controls, a computer user can add content to a content thread hosted by a social networking site from the search results page.

### BACKGROUND

One of the difficulties that many experience on social networking sites is that social networking sites typically fail to provide robust search capabilities. True, most social network sites provide tools by which a user can typically search for a particular entity, e.g., a friend, an organization, a particular topic, etc., but the tools aren't provided that enable a user to search the content (posts, likes, etc.) associated with the entity or within one's social circle. This is especially true when a user is seeking content that may be contained in one of many comments in a series (or thread) of comments associated with a particular entity.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, Systems, computer-readable media and methods are presented for enabling a computer user to add content to a social content item of a social content thread hosted by a third party social networking site. In response to a search query, a search engine generates a search results page that includes at least one social content item that relates to the search query from a third-party social networking site. The search results page includes a user-actionable control by which the requesting computer user can add content to the content thread of the social content item from within the search results page. By interacting with the user-actionable controls, a computer user can add content to a content thread hosted by a social networking site from the search results page.

According to at least one embodiment of the disclosed subject matter, a computer-implemented method for responding to a search query from a requesting computer user. Moreover, in response to receiving the search query that identifies a query topic for which related content is desired, a first set of search results relating to the topic of the search query from a content store is identified. A second set of search results relating to the topic of the search query is also identified, the second set comprising social content items from a social content store containing items from one or more social networking sites. This second set of search results includes at least one social content item from a content thread. A search results page is generated according to the first and second sets of search results. The search results page includes at least some of the search results of the first set of search results; the at least one social content item; and a user-actionable control associated with the at least one social content item. The user-actionable control enables the requesting computer user to add content to the at least one social content item from the search results page. After generating the at least one search results page, the page is provided to the requesting computer user.

According to other aspects of the disclosed subject matter, a computer-readable medium bearing computer-executable instructions is presented. The computer-executable instructions, when executed by a processor on a computing system, carry out a method for updating a content thread of a social networking site from outside of the social networking site. The method comprises initially receiving a search query topic from a computer user. The search query topic is submitted to a search engine as a search query. In response, a search results page is received from the search engine. The search results page includes search results relating to the search query topic. These search results include a social content item from a content thread hosted by a social networking site. The search results page also includes a user-actionable control associated with the social content item for adding content to a content thread of the social content item at the social networking site. Upon detecting user interaction with the user-actionable control, the method obtains user data from the computer user to be added to the content thread of the social content item and submits that user data to the social networking from the search results page.

According to still further aspects of the disclosed subject matter, a computer system for responding to a search query is presented. The system comprises both a processor and a memory, the processor executing instructions stored in the memory as part of or in conjunction with additional components. In execution, the computer system is configured to respond to a search query from a requesting computer user. The computer system also includes a content store storing data corresponding to content accessible on a network and a social content store storing social content data from one or more social networking sites. A search results identifying component identifies search results relating to a query topic of the search query from the content store and the social content store. A search results generator is also included in the computer system and generates at least one search results page in response to search query and provides the at least one search results page to the requesting computer user. The at least one search result page includes at least some search results identified from the content store and at least one social content item from the social content store. Moreover, the search results page includes a user-actionable control associated with the at least one social content item for adding user-supplied data to the at least one social content item from the search results page.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a block diagram illustrating an exemplary networked environment suitable for implementing aspects of the disclosed subject matter, particularly in regard to providing in-line commenting to social content on a social network from a third party service;

FIG. 2 is a pictorial diagram illustrating an exemplary flow of information in regard to interacting with social content from a social network site 112 outside of the social networking site;

FIG. 3 is a flow diagram illustrating the exemplary process as set forth in regard to FIG. 2;

FIGS. 4A-4D are pictorial diagrams illustrating an exemplary search results page that includes social content from a social networking site;

FIG. 5 is a flow diagram of an exemplary routine for enabling a computer user to provide in-line commenting on a content thread from outside of the social networking site;

FIG. 6 is a flow diagram of an exemplary routine, as may be implemented by a search engine, for responding to a search query from a computer user that includes at least one social content item of a content thread from a social networking site;

FIG. 7 is a block diagram illustrating exemplary components of a computing device suitable for implementing aspects of the disclosed subject matter; and

FIG. 8 is a block diagram illustrating components of an exemplary search engine suitable for implementing aspects of the disclosed subject matter, particularly in regard to responding to search queries with one or more search results pages that include at least one social content item.

### DETAILED DESCRIPTION

For purposes of clarity, the use of the term “exemplary” in this document should be interpreted as serving as an illustration or example of something, and it should not be interpreted as an ideal and/or a leading illustration of that thing. A social networking site refers to an online service in which a computer user can interact with other people, causes, organizations, events and groups for various purposes, including by way of illustration and not limitation, shared interests, activities, backgrounds, or real-life connections. “Entity” will be used as a general term to refer to an identifiable thing, such as (by way of illustration and not limitation) users, causes, interests, events, organizations, and the like. Of course, while each of these is an entity, each entity has a particular type, e.g., person, group of persons, organization, interest, event, etc. On a social networking site a user can typically establish a social network of other users and groups, causes, etc. Typically, social networking sites allow computer users to share ideas, pictures, posts, activities, events, and interests with people and groups in their social network.

While most social network sites typically provide tools by which a user can search for a particular entity, e.g., a friend, an organization, a particular topic, etc., the tools aren't provided that enable the user to search the content (posts, likes, etc.) associated with the entity or within one's social circle. Fortunately, at least some search engines now provide a means by which a user can search the content of social networks, including finding content that is contained within a thread of comments. However, many users, after finding the desired content, will also wish to interact with the content: “liking” any one of the posts/comments in the thread, adding a comment to the existing thread, and the like. To do this after finding the desired content, the user must switch from the search engine where the desired content was “found” to the social networking site where the user must first “re-find” the sought-for content and then interact with that content. This, of course, is inefficient and frustrating to the user that wishes to comment on an existing thread.

In addition to enabling a user to create a social network, social networking sites also provide space for each entity in which content may be posted. In particular, the social networking sites provide the space allow the users (entities—by way of controlling users/groups) to add content to that space. The content may include, by way of illustration and not limitation, hyperlinks that reference content on a network, images, textual content, video, an indication that a user is in favor of the entity (a “like”), and so on. Other entities (in compliance with applicable restrictions) may view and/or interact with the content that an entity posts in its space. Entities (in compliance with applicable restrictions) may also post content in the space of other entities. Further, entities may add to content that is posted on the social networking site. When additional subject matter is added to a content post, the original content and additional subject matter is considered to be a “content thread.” This additional subject matter may include any type of content or indication of preference/favor as may be added to any entity.

The term “navigate,” as used in this document, refers to a computer user operating a computer to cause a content viewing application (referred to as a “browser”) to retrieve information/content from a location specified by an network address (e.g., a URL or URI). Often, though not exclusively, this “navigation” occurs when the computer user interacts with a hyperlink—content (often textual content) that is associated with a network address and which is configured to retrieve the content from the network address upon user interaction in a browser. As those skilled in the art will appreciate, in this process while the content is, in fact, retrieved from network sites and displayed on the local computer, this activity is often referred to as navigating to that site.

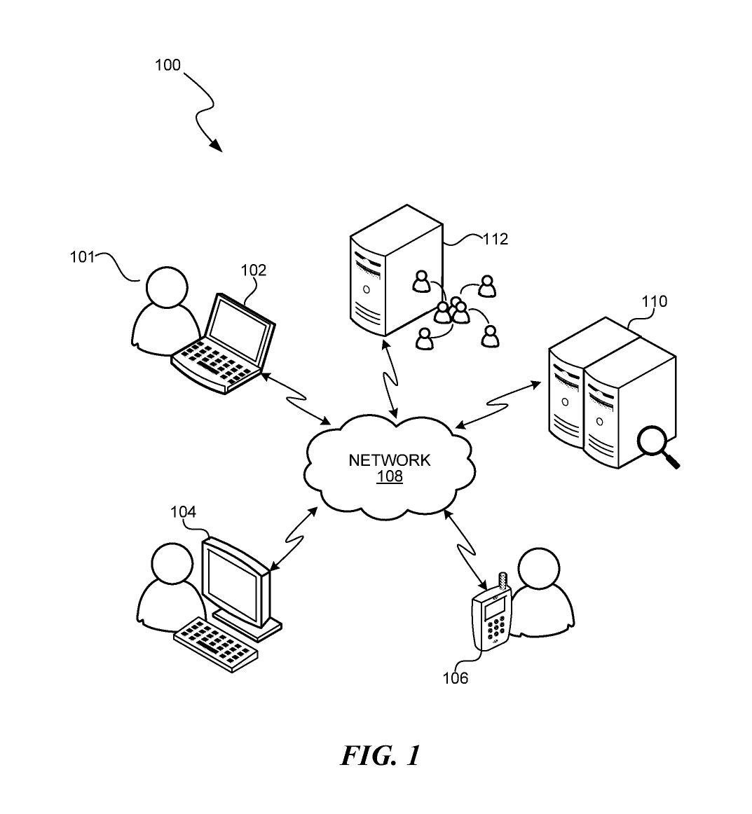

Turning to FIG. 1, FIG. 1 is a block diagram illustrating an exemplary networked environment 100 suitable for implementing aspects of the disclosed subject matter, particularly in regard to providing in-line commenting to social content on a social network from a third party service. The exemplary networked environment 100 includes one or more user computers, such as user computers 102-106, connected to a network 108, such as the Internet, a wide area network or WAN, and the like. User computers include, by way of illustration and not limitation: desktop computers (such as user computer 104); laptop computers (such as user computer 102); tablet computers (not shown); mobile devices (such as mobile device 106); game consoles (not shown); personal digital assistants (not shown); and the like.

Also included in the exemplary networked environment are various networking sites, such as networking sites 110 and 112. A computer user, such as computer user 101, may navigate to various networking sites to view content hosted on the sites, as described above. By way of example and not limitation, in the exemplary networked environment 110, the networked sites include a social networking site 112 and a search engine 110. Of course, those skilled in the art will readily appreciate that there may be any number of networked sites with a network 108. However, for simplicity in description only the two, the social networking site 112 and the search engine 110 are illustrated.

As indicated above, the social networking site 112 corresponds to an online service in which a computer user can build and interact with social networks or social relations with other people, groups, and entities for various purposes, including by way of illustration and not limitation, shared interests, activities, backgrounds, or real-life connections. As will be readily appreciated, as various users begin posting content on the social networking site 112, content threads can become large, social networks can become large, and it is easy to lose track of interesting or relevant content found in a content thread in regard to an entity—whether or not the entity is in one's social network. Fortunately, at least some search engines, such as search engine 110, provide the ability to search the various content threads for desired content.

As will be readily appreciated, a search engine, such as search engine 110, is an online service that (among other things) responds to search queries with one or more search results. A search query identifies the desired subject matter through the use of query terms. These query terms typically identify the subject matter as well as limit the scope of matching subject matter and the like. The search engine receives the search query, determines what subject matter the query references, identifies one or more references to subject matter that are the most likely candidates of the requested subject matter, generates one or more search results pages of search results, and returns at least the first search results page to the content. The search engine references content stores (typically references to content in an indexed content store) that it maintains. Included in these content stores may be a recent snapshot of the various content/content threads from one or more social network sites, such as social networking site 112. Thus, when a computer user, such as computer user 101, submits a search query for subject matter/content that may be found on a social networking site, such as social networking site 112, the search engine 110 can locate the information in the content store and return the information to the computer user.

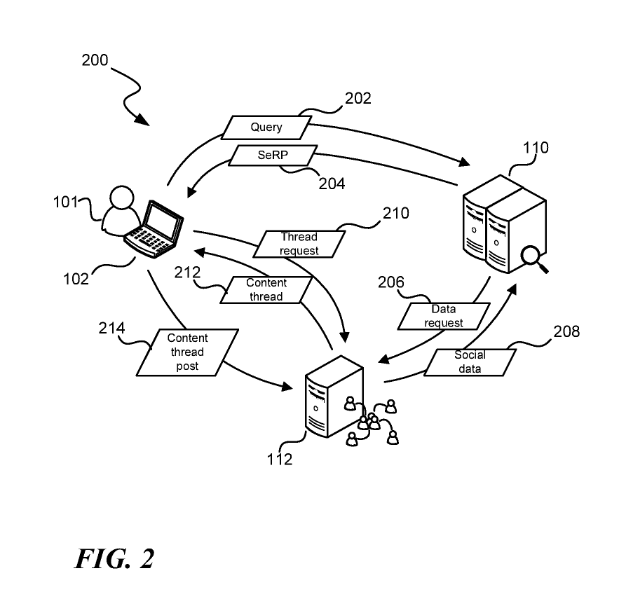

To better understand the process of providing in-line commenting to social content on a social network from a third party service (such as search engine 110), reference is now made to FIG. 2. FIG. 2 is a pictorial diagram illustrating an exemplary flow 200 of information in regard to interacting with social content from a social network site 112 outside of the social networking site. The process begins with the computer user 101, via user computer 102, submitting a search query 202 to the search engine 110. For purposes of this discussion, it is assumed that at least some of the desired content of the search query may be found on a social networking site 112.

In order to obtain search results from a social networking site 112, the computer user 101 should be logged into the social networking site and, in some cases, have established authorization for the search engine to obtain content in relation to the user from the social networking site 112. In some cases, the search query 202 may include credentials for logging into the social networking site 112 so that information from that site may be returned to the computer user 101.

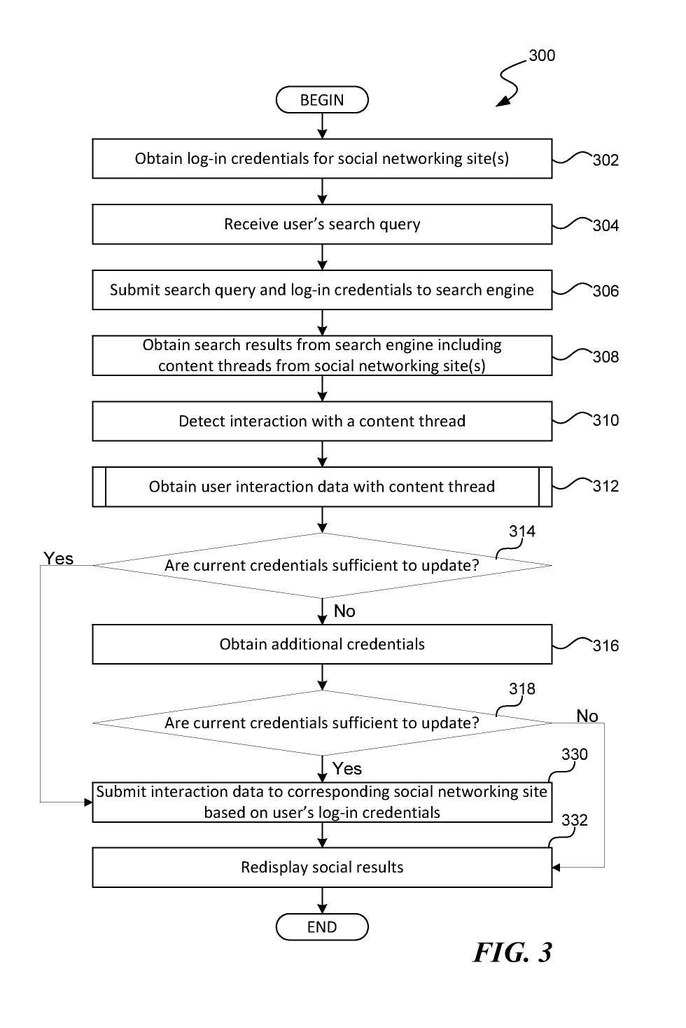

The search engine 110 identifies content that is responsive to the search query 202. From the identified content, the search engine 110 generates one or more search results pages and returns at least one search results page 204 to the computer user 101. According to aspects of the disclosed subject matter, the search results page 204 includes content that is related to the search query 202 and is obtained from a social networking site 112. As shown in FIG. 2, the search engine 110 periodically submits a data request 206 to the social networking site 112 for the latest content. In response, the social networking site 112 replies with the social data 208 which is stored for a period of time by the search engine 110 and used in responding to the search query 202. A more detailed description of the process of identifying search results content in response to a search query is set forth in regard to FIG. 3, discussed below.

As will be readily appreciated, the search results page 204 is displayed by the browser on the user computer 102. As discussed, in this example the search results page 204 includes content from the social networking site 112 that is responsive/related to the search query 202. Moreover, the search results page 204 is generated such that the computer user 101 may interact with the content from the social networking site. While the types of interactions may be determined by the search engine 110, in at least one embodiment the interactions include indicating favor regarding content (i.e., “liking” the content) and/or posting additional content to an existing content thread.

As should be appreciated, content threads may often be quite lengthy such that display of a single content thread in the search results page 204 (at least initially) is undesirable. Thus, according to aspects of the disclosed subject matter, a content thread may be initially represented in the search results page 204 by the head (original) content post, with the ability to expand and scroll through the expanded content thread. In light of this option, as an optimization the search engine 110 may provide only the head content of a content thread. When the computer user 101 wishes to display the entire content thread, a thread request 210 is submitted to social networking site 112 and the content thread 212 is returned to the computer user. Of course, as can be readily understood, the computer user 101 must either have already established a current logged-in connection to the social networking site 112 or provide credentials to do so.

With the content (which may include the entire content thread) available to the computer user 101, the use may add to the content of the content thread. For example, the computer user may “like” all or some of the content from the social networking site 112. Alternatively, the computer user 101 may provide other content (other than a like) to the content. As shown in FIG. 2, if the user adds to the content/content thread, a content thread post 214 is sent from the user computer 102 to the social networking site 112 where the additional post is incorporated into the content. In this manner, a post is made to a content thread of a social networking site 112 from outside of the social networking site.

Regarding liking or posting, those skilled in the art will appreciate that an indication of favor, or “liking” a content item is typically binary in nature: the computer user either “likes” the content item or he/she does not. Hence, while “liking” a content item adds to the content item (e.g., the count of computer users that “like” or favor the content item is increased) it is a predefined type of content addition. In contrast, posting content to a social content thread is much more free-form: the computer user is able to determine the subject matter, scope and nature of the information of the content posted to a social content thread. Accordingly, adding content to the content of a content thread may comprise predefined additions (such as indications of favor) or free-form additions (such as content posts).

Turning now to FIG. 3, FIG. 3 is a flow diagram illustrating an exemplary process 300 as set forth in regard to FIG. 2. As should be understood, the exemplary process 300 is made in regard to the user computer 102, particularly in regard to an application, such as a browser application, executing on the user computer. Beginning at block 302, the log-in credentials of the computer user 101 for the social networking site 112 are obtained. As will be appreciated, the computer user's log-in credentials are used to ensure that the computer user gains access to only that content to which the computer user is authorized.

At block 304, the computer user's search query is received. At block 306 the search query is submitted to the search engine 110 along with log-in credentials of the computer user 101. At block 308, search results are received in response to the submitted search query and presented to the computer user 101. According to aspects of the disclosed subject matter, the search results include at least one content thread from the social networking site 112.

At block 310, the exemplary process 300 detects user interaction with the social networking content thread. Interaction may include expanding a content thread or adding content to an existing content thread. For purposes of this discussion, we will assume that the computer user 101 is interacting with the content thread to add additional content. Accordingly, at block 312 the process obtains the user interaction data for the content thread.

At decision block 314, an optional determination is made as to whether the computer user's credentials are sufficient to add additional content to the content thread. This is done as there may be different levels of logged-in credentials, including credentials to view content threads of the user, content threads of the computer user's social network, and/or credentials to update content threads. Additionally, different log-in credentials may be needed depending on the nature of the addition content: whether the addition is a like or whether other content is added to the content thread.

If the computer user 101 does not currently have sufficient log-in credentials, at block 316 an attempt to obtain the additional log-in credentials is made. Thereafter, at decision block 318 the determination is made as to whether the computer user has sufficient log-in credentials to add to the content thread on the social networking site 112. If yes, or if at block 314 the user already had sufficient log-in credentials, the process 300 proceeds to block 320 where the interaction data, i.e., the addition to the content thread, is submitted to the social networking site 112 based on the computer user's log-in credentials.

At block 322, the content thread is redisplayed. If the user did not have sufficient log-in credentials, then the content thread is redisplayed without the addition of subject matter from the computer user interaction. Alternatively, if the subject matter is added to the content thread, then content thread is displayed with the updated subject matter. Thereafter, the process 300 terminates. Alternatively, while not show, the process could return to block 310 for additional computer user interaction with a content thread.

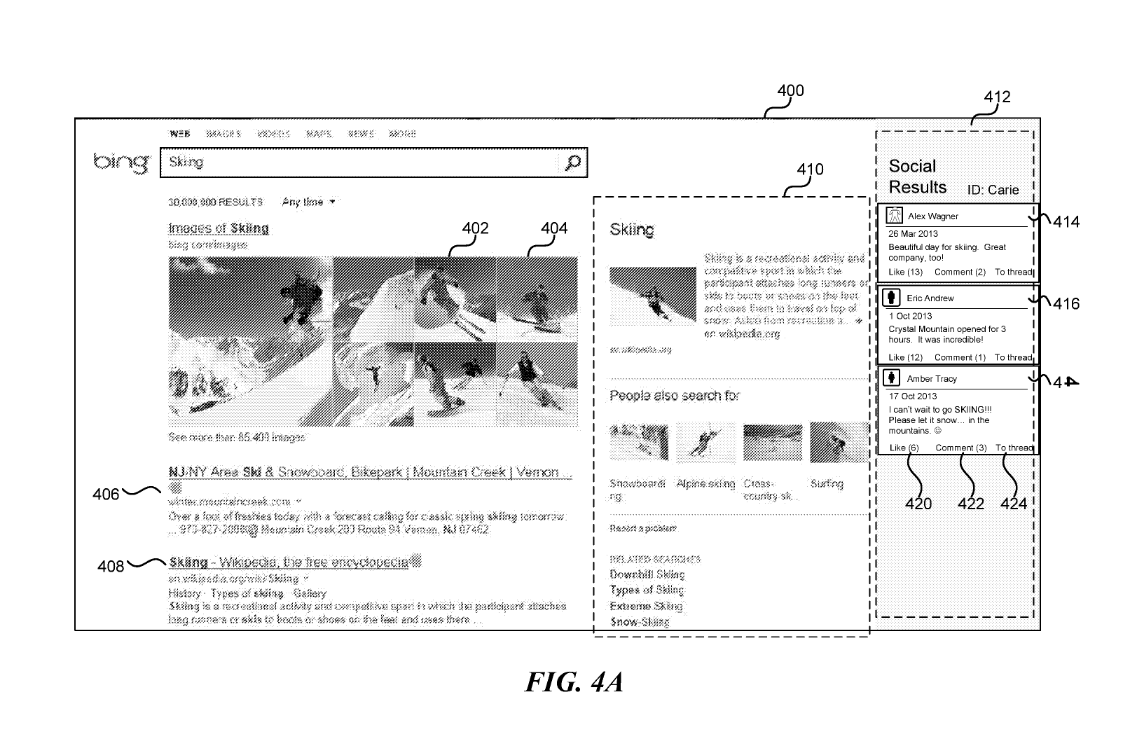

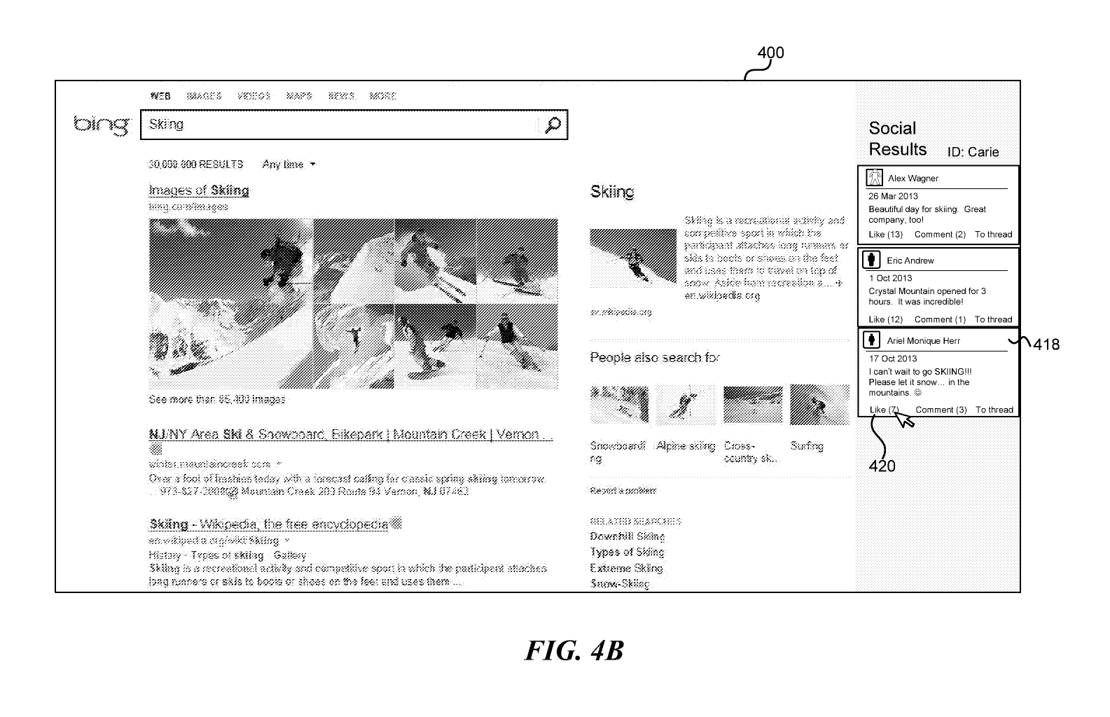

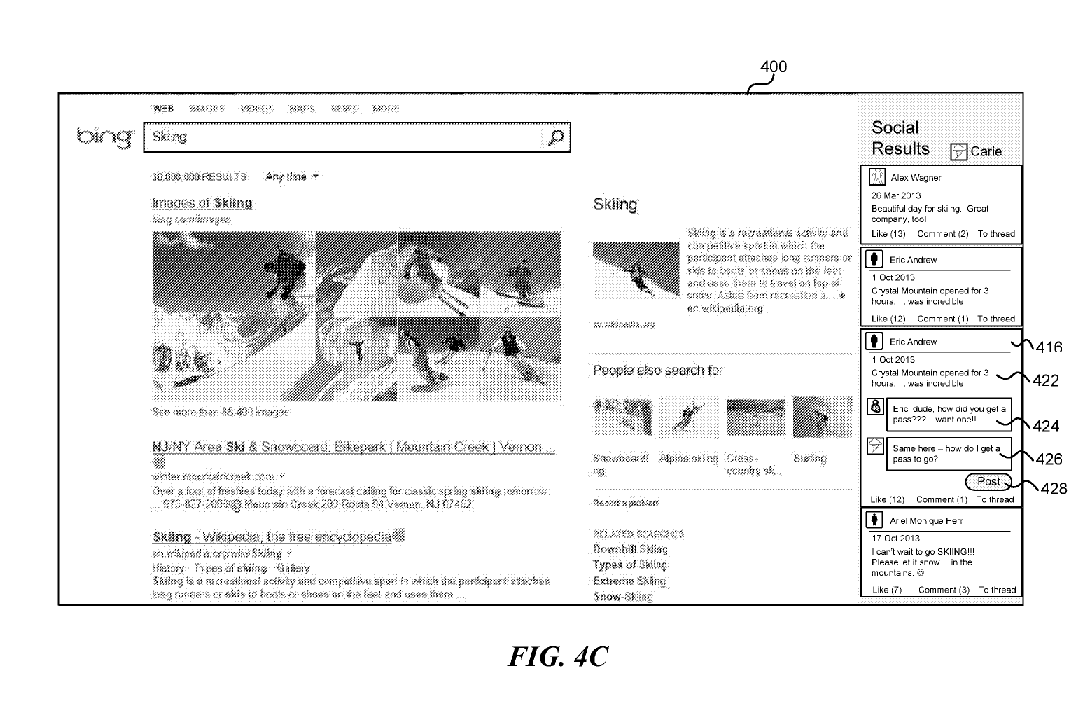

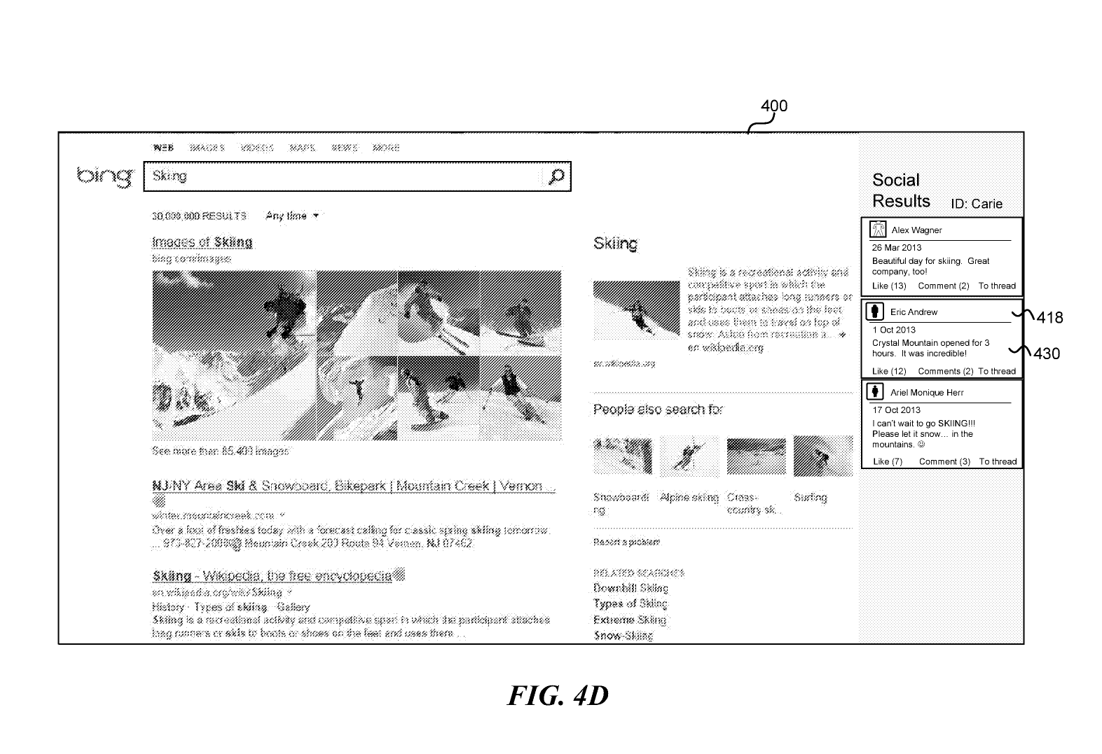

For better illustrate aspects of the process described in FIGS. 2 and 3, FIGS. 4A-4D are pictorial diagrams illustrating an exemplary search results page 400 that includes social content from a social networking site 112. More particularly, in regard to FIG. 4A, the search results page 400 (as might be displayed by a browser application executing on the computer user's computer 102) displays search results relating to the search query “Skiing”, the search results including images (such as images 402 and 404), an additional information pane 410, as well as a social content pane 412 that includes social content threads 414-418. As shown, the social content threads 414-418 include interactive user controls including a control 420 for “liking” (showing favor for) the content thread, a control 422 for adding content (a comment) to a content thread, creating a new content thread (not shown) for an entity (e.g., another user, a group, an interest page, etc.), and a control 424 for navigating directly to the content thread in the social networking site.

Turning now to FIG. 4B, the search results page 400 shows the result of a computer user interacting with the “like” control 420. More particular, after the computer user has interacted with the control 420 the like count is incremented and, correspondingly, the content thread 418 is similarly “liked” at the social networking site 112 by code generated as part of the search results page that submits the content addition to the social networking site in regard to the specific content thread for the computer user. According to additional aspects of the disclosed subject matter (not shown), by hovering a cursor over the link control 420 a list of the users that have “liked” the content thread 418 may be displayed.

While liking a content thread may be accomplished without displaying the entire content thread, such as shown in FIG. 4B, when adding content (other than simple status content such as a like) to the content thread it is often advantageous to the computer user 101 to display the entire content thread. Hence, as shown in FIG. 4C, after the computer user clicks on eh content control 422, the entirety of content thread 416 is displayed. In addition to showing the head content 422, a first additional content post 424 of the content thread is displayed as well as a field 426 for gathering additional content to post to the content thread 416. Also shown is another control 428 for posting the content gathered in the field 426 to the content thread 416 on the social networking site 112. Upon auctioning the control 428, the contents of the field 426 are posted to the social networking site 112 by code that has been generated in the search results page 400 by the search engine 110.

Turning to FIG. 4D, this pictorial diagram illustrates the search results page 400 after the computer user 101 has posted content to the content thread 416. As can be seen, the counts associated comments 430 on the content thread has been updated to reflect the computer user's submission and the content thread 416 is displayed in a collapsed/condensed state. Of course, redisplaying the content thread in a collapsed/condensed state after adding content to the content thread is just one embodiment and should not be viewed as limiting upon the disclosed subject matter. In an alternative embodiment, a content thread may remain expanded with the newly added subject matter after the computer user submits a post to the social networking site 112.

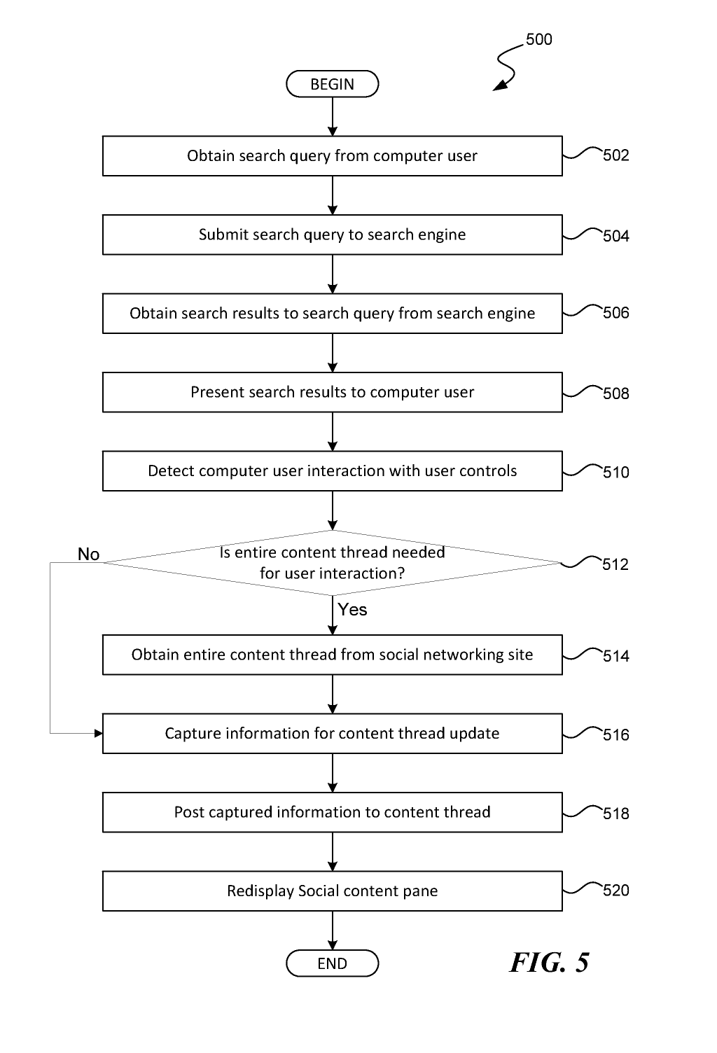

FIG. 5 is a flow diagram of an exemplary routine 500 for enabling a computer user to provide in-line commenting on a content thread from outside of the social networking site. Of course, while the exemplary routine 500 is described in regard to interacting with social networking content in the context of a search results page, this is simply one embodiment of the disclosed subject matter selected for description purposes only and should not be viewed as limiting upon the disclosed subject matter.

Beginning at block 502, the process executing on the computer user's computer obtains a search query from the computer user 101. For example, a computer user may navigate to the search engine's page and enter a search query in a field provided on the search engine's page for that purpose. At block 504, the computer user causes the search query to be submitted to the search engine 110. At block 506, in response to submitting the search query, search results (typically in the form of one or more search results pages) is obtained from the search engine 110. Included in the search results obtained from the search engine is at least one content item from a content thread hosted/maintained by a social networking site 112. Of course, as illustrated in regard to FIGS. 4A-4D, any given search results page may include several items of content from multiple content threads. Moreover, the search results may include multiple items of content from multiple social networking sites. At block 508, the search results (which include at least one content item of a content thread from a social networking site 112) is displayed to the computer user.

At block 510, the routine 500 detects computer user interaction with a user-actionable control related to a social network content item (an item of content of a content thread hosted/maintained by a social networking site.) For example, the routine 500 may detect that the computer user wishes to express a favorable view regarding the content item (i.e., “liking” the content item) as shown in FIG. 4B. Alternatively, the routine 500 may detect that the computer user wishes to comment on the content item/content thread as discussed in regard to FIG. 4C. Other user interactions with a content thread may also be supported.

At decision block 512, a determination is made as to whether the entire content thread (not just the social network content item) is needed for the computer user interaction. If yes, at block 514 the routine 500 obtains the entire content thread from the corresponding social networking site 112. The routine 500 may call on one or more services available within the executing program (e.g., the browser application) or the search results page to obtain the entire content thread from the corresponding social networking site. Alternatively, the routine 500 may obtain the entire content thread by way of a request to the search engine 110. Irrespective of the manner/route in which the routine 500 obtains the entire content thread, after obtaining the thread the routine 500 proceeds to block 516.

At block 516, the routine 500 capture the information for updating the content thread. Capturing the information may include capturing that the computer user “likes” a content item or capturing any data the computer user inputs to post as a content item to the content thread. At block 518, the routine 500 posts the captured information/data to the content thread on the corresponding social networking site. According to one embodiment, the search results page includes the necessary executable code to directly interact with the social networking site 112 to post the captured information. Alternatively, the search results page may include executable code that indirectly posts the captured information to the social networking site by way of the search engine 110. Other options for submitting the captured data to the social networking site may also be implemented.

Optionally, at block 520, after having posted the captured information to the content thread on the corresponding social networking site, the display of the content thread in the search results page may be updated (such as shown by and discussed in regard to FIGS. 4B and 4D). Thereafter, the routine 500 terminates.

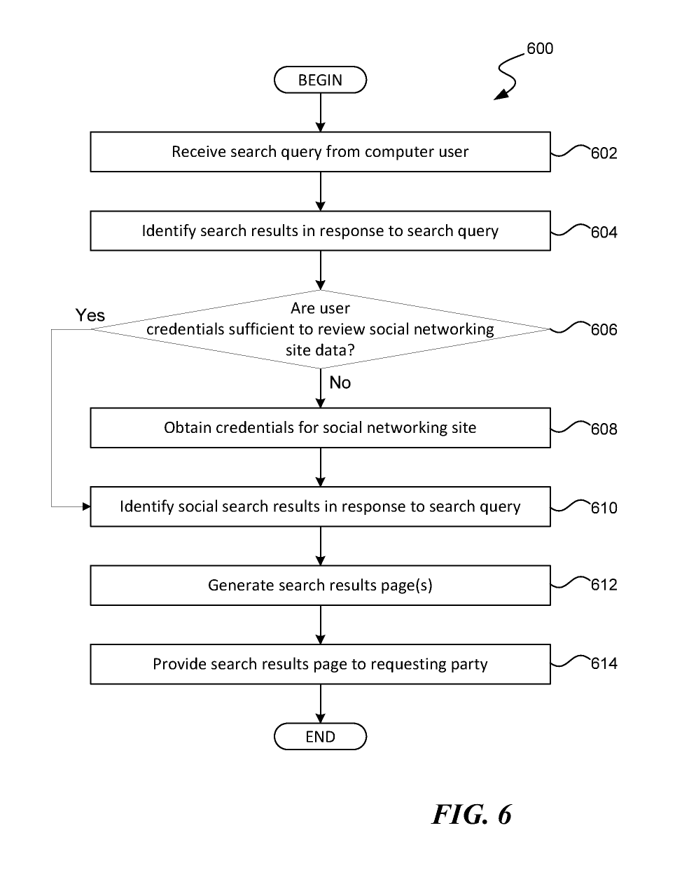

FIG. 6 is a flow diagram of an exemplary routine 600, as may be implemented by a search engine 110, for responding to a search query from a computer user that includes at least one social content item of a content thread from a social networking site 112. Beginning at block 602, the routine 600 receives a search query from a computer user. As will be readily appreciated, the search query identifies a topic for which content is sought by the requesting computer user. According to aspects of the disclosed subject matter, the requesting computer user's log-in credentials with one or more social networking sites may be included with the search query. Alternatively (not shown) the requesting computer user's log-in credentials may be obtained subsequent to receiving the search query and before identifying social search results. At block 604, search results are identified in response to the search query. As will be readily appreciated, search results are identified according to their relevance to the search query. These search results are typically identified in a content store, often an indexed content store, which the search engine 110 maintains with regard to content available on the network 108.

At decision block 606, a determination is made as to whether the requesting computer user has provided/established sufficient credentials to review and/or access data from the one or more social networking sites. If not, at block 608 the search engine may engage with the computer user (or act on the computer user's behalf) to obtain the requisite log-in credentials.

At block 610, social search results (i.e., content from the one or more social networking sites) are identified that are relevant and responsive to the received search query. According to one, non-limiting embodiment of the disclosed subject matter, social content (i.e., the latest content from the one or more social networking sites) is stored by the search engine 110 in a social content store. Moreover, the search engine 110 periodically updates the social content in the social content store.

At block 612, one or more search results pages are generated based on the identified search results from the content store and the social content store such that a search results page includes search results identified from the search engine's content store and also includes at least one social content item from the social content store. In addition, the search engine generates the search results pages such that the social content items are associated with user-actionable controls to enable to the computer user to interact with the social content items, including the ability to view and add to the content thread of the social content items included from within the generated search results pages. According to aspects of the disclosed subject matter, the user-actionable controls include a count as to the number of other users that have similarly added content to the content thread. For example, with reference to FIG. 4A, user-actionable control 420 includes an indication of the number of times “(6)” that the social content item has been “liked,” and user-actionable control 422 includes an indication of the number of content posts “(3)” that have been made to the corresponding content thread on the social networking site.

After generating one or more search results pages, the routine 600 returns at least a first search results page to the computer user in response to the submitted search query. Of course, while not shown but know to those skilled in the art, additionally generated search results pages may be provided to the computer user in response to the submitted search query. Thereafter, the routine 600 terminates.

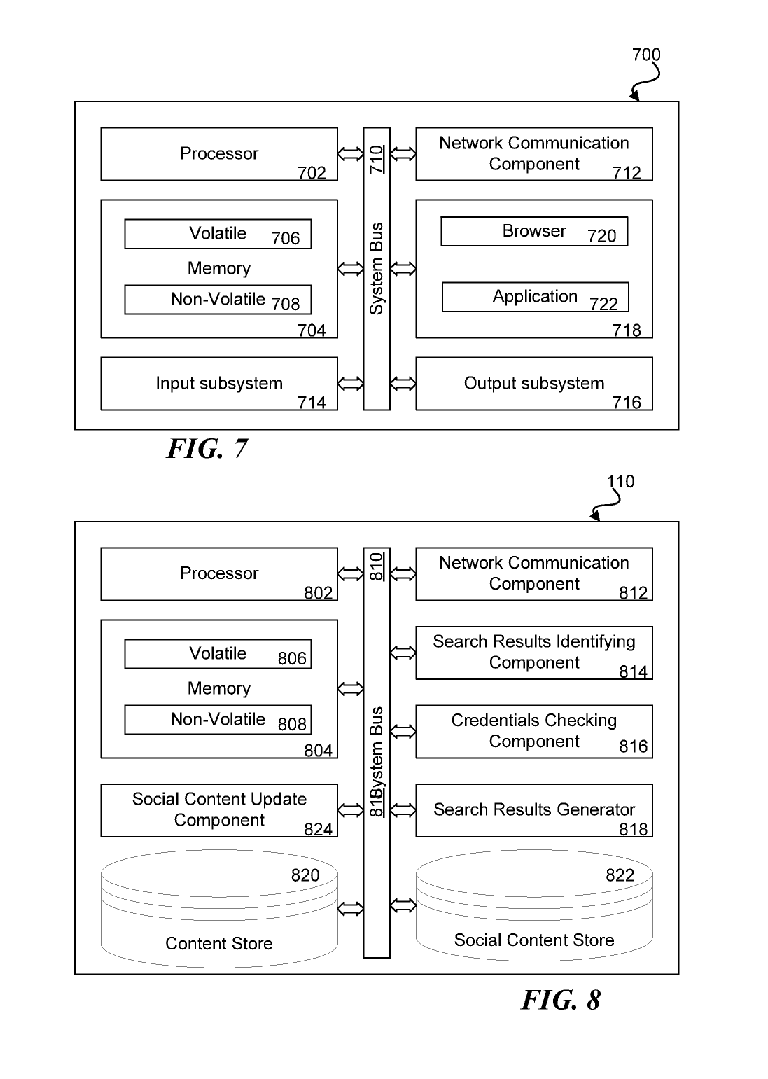

Regarding the exemplary routines 500 and 600 described above, while these routines are expressed in regard to discrete steps, these steps should be viewed as being logical in nature and may or may not correspond to any actual and/or discrete steps of a particular implementation. Nor should the order in which these steps are presented in the various routines be construed as the only order in which the steps may be carried out. Moreover, while these routines include various novel features of the disclosed subject matter, other steps (not listed) may also be carried out in the execution of the routines. Further, those skilled in the art will appreciate that logical steps of these routines may be combined together or be comprised of multiple steps. Steps of routines 500 and 600 may be carried out in parallel or in series. Often, but not exclusively, the functionality of the various routines is embodied in software (e.g., applications, system services, libraries, and the like) that is executed on computer hardware and/or systems as described below in regard to FIGS. 7 and/or 8. In various embodiments, all or some of the various routines may also be embodied in hardware modules, including but not limited to system on chips, specially designed processors and or logic circuits, and the like on a computer system.

While many novel aspects of the disclosed subject matter are expressed in routines (such as routines 500 and 600 of FIGS. 5 and 6) embodied in applications, also referred to as computer programs, apps (small, generally single or narrow purposes, applications), and/or methods, these aspects may also be embodied as computer-executable instructions stored by computer-readable media, also referred to as computer-readable storage media. As those skilled in the art will recognize, computer-readable media can host computer-executable instructions for later retrieval and execution. When the computer-executable instructions stored on the computer-readable storage devices are executed, they carry out various steps, methods and/or functionality, including the steps described above in regard to routines 500 and 600. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this disclosure, however, computer-readable media expressly excludes carrier waves and propagated signals.

Turning now to FIG. 7, FIG. 7 is a block diagram illustrating exemplary components of a computing device 700, such as any of user computers 102-106, suitable for implementing aspects of the disclosed subject matter. As shown in FIG. 7, the exemplary computing device 700 includes a processor 702 (or processing unit) and a memory 704 interconnected by way of a system bus 710. As those skilled in the art will appreciated, memory 704 typically (but not always) comprises both volatile memory 706 and non-volatile memory 708. Volatile memory 706 retains or stores information so long as the memory is supplied with power. In contrast, non-volatile memory 708 is capable of storing (or persisting) information even when a power source is not available. Generally speaking, RAM and CPU cache memory are examples of volatile memory whereas ROM and memory cards are examples of non-volatile memory. Other examples of non-volatile memory include storage devices, such as hard disk drives, solid-state drives, removable memory devices, and the like.

The processor 702 executes instructions retrieved from the memory 704 in carrying out various functions, particularly in regard to enabling a computer user to interact with social content items outside of the corresponding social networking site, where the interactions include viewing and adding to the content threads of the social content items. The processor 702 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: mini-computers; mainframe computers, personal computers (e.g., desktop computers, laptop computers, tablet computers, etc.); handheld computing devices such as smartphones, personal digital assistants, and the like; microprocessor-based or programmable consumer electronics; game consoles, and the like.

The system bus 710 provides an interface for the various components to inter-communicate. The system bus 710 can be of any of several types of bus structures that can interconnect the various components (including both internal and external components). The exemplary computing device 700 also includes a network communication component 712 for interconnecting the computing device 700 with other computers, devices and services on a computer network including a search engine 110 and one or more social networking sites, such as social networking site 112. The network communication component 712 may be configured to communicate with these other, external devices and services via a wired connection, a wireless connection, or both.

The exemplary computing device 700 also includes one or more applications 718, including a network browser 720 or other application 718. As indicated above, a network browser 720 provides to the computer user the ability to navigate various network sites, including social networking sites and a search engine 110. Through a browser application (or other service that provides network navigation) the computer user can view interact with a search engine, including submitting search queries to the search engine, and view search results pages that are generated in response to a search query. The browser application 720 further provides the ability to interact with user-actionable controls in the various pages of content that are viewed by the browser. Other applications may include platforms and services that support the execution of code within a browser application 720. Examples include Microsoft's .Net framework, Oracle's Java, and the like.

Also included in the exemplary computing device 700 are an input subsystem 714 and an output subsystem 716. The input subsystem 714 includes services and devices that enable the computer user to interact with the computer, including the ability to interact with user-actionable controls presented by a browser application 720. Examples of devices with the input subsystem include, by way of illustration and not limitation, keyboards, positioning devices (mouse, touch pad, joy stick, and the like), audio input devices, touch sensitive surfaces, video and image input devices, stylus input devices, and the like where each of the devices has a corresponding interface service to the computing device 700. Similarly, the output subsystem includes displays, speakers, haptic feedback devices, and the like and the corresponding interface services.

Turning now to FIG. 8, FIG. 8 is a block diagram illustrating components of an exemplary search engine 110 suitable for implementing aspects of the disclosed subject matter, particularly in regard to responding to search queries with one or more search results pages that include at least one social content item. Similar to the exemplary computing device 700, the exemplary computing device 110 includes a processor 802 (or processing unit) and a memory 804 interconnected by way of a system bus 810. As those skilled in the art will appreciated, memory 804 typically (but not always) comprises both volatile memory 806 and non-volatile memory 808.

The processor 802 executes instructions retrieved from the memory 804 in carrying out various functions, particularly in regard to identifying search results, including social content items, and generating one or more search results pages that include the social content items. The processor 802 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: mini-computers; mainframe computers, personal computers (e.g., desktop computers, laptop computers, tablet computers, etc.); handheld computing devices such as smartphones, personal digital assistants, and the like; microprocessor-based or programmable consumer electronics; game consoles, and the like.

The system bus 810 provides an interface for the various components to inter-communicate. The system bus 810 can be of any of several types of bus structures that can interconnect the various components (including both internal and external components). The exemplary computing device 800 also includes a network communication component 812 for interconnecting the computing device 800 with other computers, devices and services on a computer network including a one or more social networking sites, such as social networking site 112, and user computers such as user computers 102-106. The network communication component 812 may be configured to communicate with these other, external devices and services via a wired connection, a wireless connection, or both.

The exemplary computing device 800 also includes a content store 820. As indicated above, the content store includes data regarding content that is available at various locations throughout the network 108. Typically, though not exclusively, the content store is indexed according to various keys. Further, the content store may store the content that is available at various locations throughout the network, references to the content at their various locations, or a combination of the two. Further still, while the content store 820 and the social content store 822 are illustrated as separate content stores, this is for illustration only and not intended to be limiting upon the disclosed subject matter.

As mentioned, the exemplary computing device 800 also includes a social content store 822. The social content store 822 includes social content items from one or more social networking sites, such as social networking site 112. According to various embodiments of the disclosed subject matter, the search engine 110 includes a social content update component 824 that periodically obtains the latest social content items from the one or more social networking sites and stores this information in the social content store 822 in order to provide the most up-to-date information when responding to a search query. In one embodiment, the information stored in the social content store comprises references to the content at the social networking sites. Alternatively, copies of the social content items may be stored in the social content store. As with the content store 820, elements of the social content store 822 may be indexed according to various keys, thereby facilitating quick identification and access of the data.

Also included in the exemplary computing device 800 are a search results identifying component 814, a credentials checking component 816, and a search results generator 818. The search results identifying component 814 identifies search results that are relevant to a received search query. The search results identifying component 814 identifies search results from both the content store 820 and social content store 822. Of course, accessing social content items often requires the appropriate log-in credentials and the credentials checking component 816 is used to determine whether or not the requesting computer user has established any requisite credentials. The search results generator 818 is used to generate one or more search results pages based on the search results identified by the search results identifying component 814. At least some of the generated search results pages include at least one social content item with corresponding user-actionable controls by which the user may interact with that social content item. The search results generator 818 further generates the at least some search results pages with the underlying code or functionality to enable the user-interactivity of interacting with the user-actionable controls and of updating the content thread of a social content item with information provided by the computer user.

Those skilled in the art will appreciate that the various components of the exemplary computing devices 700 and 800 of FIGS. 7 and 8 may be implemented as executable software modules within the computing device, as hardware modules (including SoCs—system on a chip), or a combination of the two. Moreover, each of the various components may be implemented as an independent, cooperative process or device, operating in conjunction with one or more computer systems. It should be further appreciated, of course, that the various components described above in regard to the exemplary computing device 700 should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computer system may be combined together or broke up across multiple actual components and/or implemented as cooperative processes on a computer network.

While various novel aspects of the disclosed subject matter have been described, it should be appreciated that these aspects are exemplary and should not be construed as limiting. Variations and alterations to the various aspects may be made without departing from the scope and intent of the disclosed subject matter.

What is claimed:

1. A computer-implemented method for responding to a search query from a requesting computer user, the method comprising each of the following as implemented on a computing device:
receiving a search query from a computer user, the search query identifying a topic for which related content is desired;
identifying a first set of search results relating to the topic of the search query from a content store;
identifying a second set of search results relating to the topic of the search query from a social content store storing social content items from one or more social networking sites, wherein the second set of search results includes at least one social content item;
generating a search results page, wherein the generated search results page includes:
at least some of the search results of the first set of search results;
the at least one social content item; and
a user-actionable control associated with the at least one social content item for adding content to the at least one social content item from the search results page; and
providing the generated search results in response to the search query.

2. The computer-implemented method of claim 1, wherein the generated search results page includes a user-actionable control for viewing the entire content thread of the social content item.

3. The computer-implemented method of claim 1, wherein adding content to the at least one social content item from the search results page comprises adding an indication of favor to the social content item.

4. The computer-implemented method of claim 1, wherein adding content to the at least one social content item from the search results page comprises obtaining content from the computer user and posting the content as a new social content item to a content thread of the social content item.

5. The computer-implemented method of claim 1 further comprising:
determining whether the requesting computer-user has established sufficient log-in credentials to view social content items from a social networking site; and
upon determining that the requesting computer-user has not established sufficient log-in credentials, assisting the computer-user to establish sufficient log-in credentials to view social content items from the social networking site.

6. The computer-implemented method of claim 1, wherein generating the search results page according to the first and second sets of search results comprises generating the search results page to further include code for updating a content thread of the social content item at a corresponding social networking site user content upon user interaction of the user-actionable control associated with the at least one social content item.

7. The computer-implemented method of claim 1, wherein the user-actionable control associated with the at least one social content item for adding content to the at least one social content item from the search results page includes a count of the number of previous additions to a social content thread of the social content item at a corresponding social networking site.

8. The computer-implemented method of claim 1 further comprising periodically updating the social content store with recent data from one or more social networking sites.

9. A computer-readable medium bearing computer-executable instructions which, when executed by a processor on a computing device, carry out a method for updating a content thread of a social networking site from outside of the social networking site, comprising:
receiving a search query topic from a computer user;
submitting the search query topic as a search query to a search engine;
receiving a search results page from the search engine in response to the search query, the search results page including:
search results relating to the search query topic including at least one social content item from a content thread hosted by a social networking site; and
a user-actionable control associated with the social content item for adding content to a content thread of the social content item at the social networking site;
detecting user interaction with the user-actionable control;
obtaining user data from the computer user to be added to the content thread of the social content item;
submitting the user data to the social networking site from the search results page, the data identifying the social content thread, and the content data to be added to the social content thread.

10. The computer-readable medium of claim 9, wherein the method further comprises:
determining whether the computer user has established sufficient log-in credentials to add the content data to the social content thread of the social networking site; and
obtaining established sufficient log-in credentials to add the content data to the social content thread of the social networking site upon determining that sufficient log-in credentials have not yet been established.

11. The computer-readable medium of claim 9, wherein the user-actionable control comprises a user-actionable control for providing an indication of favor of the social content item.

12. The computer-readable medium of claim 9, wherein the user-actionable control comprises a user-actionable control for posting additional content to the content thread of the social content item.

13. The computer-readable medium of claim 12, wherein the method further comprises:
obtaining all social content items of the social content thread;
presenting all social content items of the social content thread to the computer user; and
presenting a field for gathering user data to post to the social content thread;
wherein obtaining user data from the computer user to be added to the content thread of the social content item comprises obtaining user data from the field for gathering user data.

14. The computer-readable medium of claim 9, wherein the user-actionable control includes an indication of the number of times other computer users have added user data to social content item.

15. A computer system for responding to a search query, the system comprising a processor and a memory, wherein the processor executes instructions stored in the memory as part of or in conjunction with additional components in responding to a search query from a requesting computer user, and further comprising:
a content store storing data corresponding to content accessible on a network;
a social content store storing social content data from one or more social networking sites;
a search results identifying component that identifies search results relating to a query topic of the search query from the content store and the social content store; and
a search results generator that generates at least one search results page in response to search query and provides the at least one search results page to the requesting computer user, wherein the at least one search result page includes:
at least some search results identified from the content store;
at least one social content item from the social content store; and
a user-actionable control associated with the at least one social content item for adding user-supplied data to the at least one social content item from the search results page.

16. The computer system of claim 15, wherein the user-actionable control comprises a user-actionable control for adding an indication of favor to the social content item from the generated search results page.

17. The computer system of claim 15, wherein the user-actionable control comprises a user-actionable control for posting user-supplied data to a social content thread of the social content item.

18. The computer system of claim 15 further comprising a credentials checking component configured to determine whether the log-in credentials of the requesting computer user are sufficient to access social content in the social content store, and further configured to assist the requesting computer user to obtain sufficient log-in credentials when the credentials checking component determines that the requesting computer-user's log-in credentials are not sufficient to access the social content in the social content store.

19. The computer system of claim 15, wherein the search results generator further generates the at least one search results page with executable instructions for adding the user-supplied data to the at least one social content item on the corresponding social networking site over the network.

20. The computer system of claim 15, wherein the search results generator includes a count of the number of previous additions to the social content thread of the social content item as part of the user-actionable control.
